(19) United States
(12) Patent Application Publication
(10) Pub. No.: US 2003/0118894 A1
(43) Pub. Date: Jun. 26, 2003

(54) Galvanic element having a thin, flat, and flexible metal housing

(75) Inventors: Fatima Birke-Salam, Ellwangen (DE); Thomas Wohrle, Ellwangen (DE); Peter Birke, Ellwangen (DE); Konrad Holl, Aalen-Dewangen (DE); Stefan Furst, Schwabsberg (DE); Heinrich Stelzig, Rosenberg (DE); Dejan IIic, Ellwangen (DE)

Correspondence Address: SCHNADER HARRISON SEGAL & LEWIS, LLP, 1600 MARKET STREET, SUITE 3600, PHILADELPHIA, PA, 19103

(73) Assignee: VARTA Microbattery GmbH, Hannover (DE)

(21) Appl. No.: 10/327,255

(22) Filed: Dec. 20, 2002

(30) Foreign Application Priority Data
Dec. 20, 2001 (DE) 101 62 832.3

(51) Int. Cl. H01M 2/02; H01M 2/08

(52) U.S. Cl. 429/127; 429/176; 429/185

(57) ABSTRACT

A thin, flat and flexible galvanic element, its metallic housing including a foil fabricated from a copper material having a copper content of at least about 95% by weight and a light-metal alloying additive, where the copper and alloying light metal differ in atomic number by at least 15, but no more than 26, and have melting points that differ by at least about 400° C., but no more than about 950° C., the alloying metal is monovalent to trivalent in compounds and modifies the face-centered cubic hard-sphere packing of the copper during alloying such that its mass density of about 8.94 g/cm³ is altered by at least about 0.03 g/cm³, and the foil has an adhesive coating on its side facing the interior of the housing.

### RELATED APPLICATION

This application claims priority of German Patent Application No. 101 62 832.3, filed Dec. 20, 2001.

### FIELD OF THE INVENTION

This invention relates to a galvanic element having a thin, flat, and flexible metallic housing.

### BACKGROUND

Extremely thin, flexible, galvanic elements having an overall thickness of less than 0.5 mm are required as, for example, energy-storage devices on “active smart cards.” The flat energy-storage devices employed on such thin, electronic chip cards are intended to serve as power supplies for their IC-chips or other components, such as built-in miniature sensors.

In the case of particularly thin energy-storage devices having thicknesses of less than 0.5 mm, the design of their housings and the materials employed for fabricating their housings are problematic. A solid metal foil or a plastic-metal-plastic laminate may serve as their cup and cover plate. A known example of such materials is coated, laminated aluminum foil. However, the latter is usually unsuitable, since laminates of that type are sufficiently durable only in thicknesses falling within the range of 80 μm-120 μm. Such large thicknesses entail adding “dead” material, which is undesirable, since it has a major, adverse effect on the energy densities of fully assembled cells. In the case of applications of the aforementioned type, efforts have been devoted to developing housings fabricated from solid metal foils that, in spite of their typical thicknesses of 15 μm-35 μm, preferably 16 μm-25 μm, having high mechanical flexibilities and durabilities, combined with excellent adhesive properties when employed as sealing foils and electrodes, that also will not damage optional plastic shroudings, if any, when deformed.

The solid metal housings of button cells typically consist of stainless steel, bimetallic (nickel-stainless steel) laminates, or trimetallic (nickel-stainless steel-copper) laminates. Their outer, nickel layers are beneficial to generating contacts to consumers. An inner copper layer may be beneficial both to contacts to the interiors of cells, and on electrochemical grounds.

However, rolling stainless steel down to thicknesses of 20 μm-25 μm is difficult and extremely expensive. The aforementioned problem becomes much more serious if taking advantage of the aforementioned benefits of bimetallic or trimetallic laminates is also intended, since adding one, two or more metallic layers increases their thickness. Furthermore, rolled materials have very smooth surfaces that make internally contacting electrodes and insulating sealing foils inserted between cups and cover plates, as well as externally contacting drains, much more difficult. In particular, roughening the surfaces of thin, stainless-steel foils is extremely difficult on a mass-production scale and virtually no solutions to that problem exist.

Many metal foils, for example, nickel foils, may be eliminated from consideration due to their electrochemical incompatibility.

Copper best meets the requirements that have been mentioned thus far, since it may be readily rolled into foils having thicknesses extending down to 10 μm, is much easier to contact the vicinities of external drains than stainless steel, and its hardness, or softness, may be altered by rolling or annealing. All of those processes are inexpensively performed, and copper has an electrochemical-durability window that is sufficiently broad for many types of galvanic elements.

Repeated bending about various card axes (the ISO bending test) is of major significance when thin galvanic elements are employed on active smart cards, where no wrinkles, tearing, or damage to their outer housings (in the case of plastic cards) and galvanic cells should occur.

It would therefore be advantageous to provide a galvanic element that meets the demands imposed on mechanical durability relating to resistance to bending and torsional stresses when employed on active chip cards.

### SUMMARY OF THE INVENTION

This invention relates to a galvanic element having a thin, flat and flexible metallic housing, wherein the housing includes a foil fabricated from a copper material having a copper content of at least about 95% by weight and a light-metal alloying additive, where the cooper and alloying light metal differ in atomic number by at least 15, but no more than 26, and have melting points that differ by at least about 400° C., but no more than about 950° C., and wherein the alloying metal is monovalent to trivalent in compounds and modifies face-centered cubic hard-sphere packing of the copper during alloying such that its mass density of about 8.94 g/cm³ is altered by at least about 0.03 g/cm³, and an adhesive coating on a side of the foil facing an interior portion of the housing.

### DETAILED DESCRIPTION

Copper having at least one alloying additive best meets the requirements of galvanic elements employed on active chip cards. According to the invention, the element housing comprises a foil fabricated from a copper material having a copper content of at least about 95% by weight whose bulk modulus has been modified by alloying it with at least one light metal from a primary group such that a galvanic cell fabricated in that manner will comply with ISO-standards governing incorporation into “active smart cards” since it will pass the ISO bending test defined under DIN ISO 7816-1 and testing procedures defined under DIN ISO/IEC 10 373.

The atomic numbers of copper and the alloying metal(s) involved differ by at least 15, but no more than 26, and their melting points differ by at least about 400° C., but no more than about 950° C., where the large difference(s) in their atomic numbers is amplified by the greatest hard-sphere packing density due to the occupation of interstitial lattice locations by alloying metal(s) having a much smaller ionic radius/much smaller ionic radii, which has a beneficial effect on flexibility and ductility of the alloy. Concurrently, the large difference(s) in their melting points means that these bonds do not contribute to severe distortions of the copper lattice. A low melting point means a low lattice binding energy, which the alloying ions bring with them. The alloying light metal according to the invention preferably enters into divalent bonds, preferably crystallizes into the hexagonally densest hard-sphere packing configuration, and modifies the face-centered-cubic hard-sphere packing of the copper during alloying such that its mass density of about 8.94 g/cm³ will be altered by at least about 0.03 g/cm³.

Suitable as beneficial alloying metals are lithium, magnesium, and aluminum, where employing magnesium for this purpose will be particularly beneficial.

The percentage content of alloying additive ranges from about 0.01% to about 0.2% by weight, and preferably ranges from about 0.05% to about 0.15% by weight, based on the weight of the copper material.

The thicknesses of cells are preferably less than about 0.5 mm and have rated capacities of less than about 50 mAh.

It is also beneficial to electrochemically deposit a layer of copper crystallites that roughen their surface on one side of the metal-alloy foil, namely, the side that faces inwardly when cells are subsequently housed to provide adhesion for electrodes and sealing foils. A method for depositing such a layer is disclosed in German Patent Application 101 08 695.4, the subject matter of which is incorporated herein by reference.

### EXAMPLE

A paste was prepared by thoroughly mixing 77% by weight braunite (electrolytic MnO₂) that had been thermally activated at 360° C., 6% by weight graphite (Timrex KS 6), 2% by weight electrically conductive carbon black (Erachem Super P), 7% by weight polyvinylidene fluoride-hexafluoropropylene (Elf Atochem Kynar Flex 2801), and 8% by weight propylene carbonate (Merck) in acetone and the resultant paste spread onto a polyolefin (Calgard 2500 polypropylene) separator. The solvent was evaporated and the resultant strip vacuum dried at 110° C. for 48 h, and impregnated with an organolithium electrolyte having the composition 0.96 M LiClO₄ in 87% propylene carbonate/13% ethylmethyl carbonate by volume. The electrode-separator assembly was punched out into blanks measuring 1.6 cm×2.3 cm and inserted into copper-foil housings, on whose cover sides lithium had previously been pressed and whose cup sides had been coated with a graphite-based electrical-conductivity enhancer, in addition to the layer of copper crystallites. An insulating layer (sealing layer) was provided between the cup and cover plate at every location where copper contacts copper and the cup and cover plate were then ultrasonically welded. In accordance with the intention, the copper housings were alloyed with 0.11% magnesium by weight.

Galvanic cells fabricated in that manner comply with ISO-standards governing incorporation into “active smart cards” since it will pass the ISO bending test defined under DIN ISO 7816-1 and testing procedures defined under DIN ISO/IEC 10 373. Under the dynamic-bending test, the card is longitudinally arched through 2 cm and laterally arched through 1 cm at a frequency of 30 bending operations per minute (a bending frequency of 0.5 Hz). Under this test, cards must survive at least 250 bending operations in each of the four possible directions, i.e., a total of 1,000 bending operations, without sustaining damage. Under the dynamic-torsion test, cards are twisted through ±15° about their longitudinal axes at a frequency of 30 such twisting operations per minute (a twisting frequency of 0.5 Hz). The standard demands that cards survive 1,000 twisting operations, without any failures of their chips' functions or visible damage to cards.

What is claimed is:

1. A galvanic element having a thin, flat and flexible metallic housing, wherein the housing comprises:
a foil fabricated from a copper material having a copper content of at least about 95% by weight and a light-metal alloying additive, where the copper and alloying light metal differ in atomic number by at least 15, but no more than 26, and have melting points that differ by at least about 400° C., but no more than about 950° C., and wherein the alloying metal is monovalent to trivalent in compounds and modifies face-centered cubic hard-sphere packing of the copper during alloying such that its mass density of about 8.94 g/cm³ is altered by at least about 0.03 g/cm³, and
an adhesive coating on a side of the foil facing an interior portion of the housing.

2. The galvanic element according to claim 1, wherein said adhesive coating comprises electrochemically deposited copper crystallites.

3. The galvanic element according to claim 1, wherein the content of the alloying additive is about 0.01% to about 0.2% by weight, based on the weight of the copper material.

4. The galvanic element according to claim 3, wherein the additive is about 0.15% by weight.

5. The galvanic element according to claim 1, wherein the alloying additive is magnesium and crystallizes into a hexagonally dense hard-sphere packing configuration.

6. The galvanic element according to claim 1, having a cell thickness of less than about 0.5 mm and a rated cell capacity of less than about 50 mAh.

7. The galvanic element according to claim 1, wherein the light-metal alloying additive is selected from the group consisting of lithium, magnesium and aluminum.
